(19) United States
(12) Patent Application Publication
(10) Pub. No.: US 2014/0182378 A1
(43) Pub. Date: Jul. 3, 2014

(54) ENERGY HARVESTER POWERED ACCELEROMETER

(71) Applicant: KCF TECHNOLOGIES, INC., State College, PA (US)

(72) Inventors: Jacob J. LOVERICH, State College, PA (US); Stephen J. WENNER, Port Matilda, PA (US); Scott D. BROWN, Rollinsford, NH (US)

(73) Assignee: KCF TECHNOLOGIES, INC., State College, PA (US)

(21) Appl. No.: 13/731,694

(22) Filed: Dec. 31, 2012

(51) Int. Cl. G01P 15/097

(52) U.S. Cl. CPC G01P 15/097
USPC 73/514.29

(57) ABSTRACT

A sensor may include a base, a resonator centered over the base, and an accelerometer disposed in a base of the resonator. The resonator may be configured to harvest energy from vibratory motion of a host device and includes a slot disposed on a center rectangular plane of the sensor. The sensor may include a circuit arrangement disposed on the accelerometer and in the slot on the center rectangular plane of the sensor. A piezoelectric element may be mounted on the resonator and electrically coupled with the circuit arrangement. The piezoelectric element may be configured to convert vibratory energy of the resonator to electrical energy. An optional antenna may be coupled with the circuit arrangement and configured to wirelessly transmit data from the sensor to a receiving station.

### CROSS-REFERENCE TO RELATED APPLICATION

The present disclosure is related to copending U.S. patent application Ser. No. 13/______, entitled “Monolithic Energy Harvesting System, Apparatus, And Method” (Attorney Docket No. K014-7003US0), filed concurrently with the present application, the disclosure of which is incorporated herein by reference.

### TECHNICAL FIELD

The present disclosure relates generally to a sensor and, more specifically, to an accelerometer that is powered by an energy harvester, such as for example a wireless accelerometer.

### BACKGROUND

Maintenance and inspection requirements often drive the life-cycle cost of components and structures, particularly for fatigue sensitive and operation critical parts. Maintenance activities are often conducted on time intervals that are based on worst case environmental, wear, and loading conditions. However in practice component and structure usage conditions vary and therefore, structural degradation varies between each asset. Acquisition of health and usage data during use of the component or structure promises to enable tailoring of maintenance activities to each asset and thereby reducing over-conservative maintenance activity. This practices of Condition Based Maintenance (CBM) and Structural Health Monitoring (SHM) is particularly relevant to Aircraft and ground vehicles that require expensive and frequency maintenance. In the context of such vehicles, the application of CBM practices reduces scheduled and unscheduled maintenance, reduces inspection intervals, and extends the life of certain components and subsystems. In the case of structures and dynamic systems, physical sensors are required to generate factual data upon which maintenance decisions are based. In many conventional CBM implementations, sensors are wired to a data aggregator and processing unit. As sensor technology and CBM analysis techniques have improved, sensor wiring has become a major limitation to establishing favorable CBM life-cycle value statements for many applications.

Wireless technologies promises to address this problem by simplifying installation, reducing maintenance associated with wiring faults, and reducing wiring weight, which often accounts for the majority of sensor system's weight. To realize these benefits in most cases, wireless communication must be similar in robustness and function to wired systems, sensor weight including autonomous power supplies must be less than that of a wire, and sensor capability must be similar to their wired counterparts. Satisfying these requirements is a challenge because sensor power supply capability (life or average power delivery) scales directly with weight, and wireless sensor performance, including RF transmission robustness and sensor capability, depends on the energy offered by the power supply. This tradeoff between sensor weight and capability is particularly keen for rotorcraft applications.

The fundamental approach to optimally satisfying these requirements seeks to maximize the power supply energy/power density and reduce electrical power consumption of the sensor system. These two objectives contribute to defining aspects of the sensor solutions presented in this disclosure. The wireless sensor may be powered by an energy harvester rather than battery because most applications in which vibration monitoring is desired are generally conducive to energy harvesting and battery replacement is generally unacceptable. Energy harvesters for these applications must be small, lightweight, robust, and function consistently over the life the sensor. A novel solution to these issues is presented in the following disclosure.

### SUMMARY OF THE INVENTION

In one aspect of the disclosure, a wireless sensor may include a base, a resonator centered over the base, and an accelerometer disposed in the base. The resonator may be configured to harvest energy from vibratory motion of a host device and includes a slot disposed on a center rectangular plane of the sensor. The sensor may include a circuit arrangement disposed on the accelerometer and in the slot on the center rectangular plane of the sensor. A piezoelectric element may be mounted on the resonator and electrically coupled with the circuit arrangement. The piezoelectric element may be configured to convert vibratory energy of the resonator to electrical energy.

The circuit arrangement harvests and manages energy from the piezoelectric element so that it can be used by circuitry that powers the accelerometer, acquires and conditions data from the accelerometer, and then wirelessly sends the data over and RF link via an antenna to a wireless receiving station.

The particular configuration of the energy harvester mechanical resonator, accelerometer, circuit arrangement, and antenna are uniquely designed to offer a maximum packaging density and highest sensor and wireless communication performance. The arrangement of these components is important because the mechanical interface of the resonator to a host structure strongly influences its power generation performance for a given mass and size. The power generation is important because it determines how quickly data can be acquired and how far it can be reliably transmitted over the wireless link without data loss. The configuration of the accelerometer is also important because the mechanical interface between the accelerometer and the host structure determines how accurately the accelerometer is tracking the motion of the host structure. The accelerometer configuration relative to the circuit arrangement is also important because long wire lengths between the accelerometer and the circuit arrangement require additional circuitry to prevent signal degradation due to EMI. The use of additional circuitry is avoided in this design because it requires additional power consumption.

### BRIEF DESCRIPTION OF THE DRAWINGS

FIG. 1 shows an assembled version of a sensor in accordance with aspects of the disclosure.

FIG. 2 illustrates an exemplary embodiment of the sensor of FIG. 1 with the housings removed.

FIG. 3 is an exploded view of the exemplary embodiment in FIG. 2.

FIG. 4 illustrates a layout of test stand and facility for a working example described herein.

FIG. 5 is a graph of gearbox torque load profile versus time for an initial test.

FIG. 6 is a graph of gearbox vibration spectrum from a wireless accelerometer.

FIG. 7 is a graph of gearbox startup temperature profile.

FIG. 8 is a block diagram illustrating an exemplary configuration of electrical circuitry of the sensor.

### DETAILED DESCRIPTION

Reference will now be made in detail to specific embodiments or features, examples of which are illustrated in the accompanying drawings. Generally, corresponding or similar reference numbers will be used, when possible, throughout the drawings to refer to the same or corresponding parts.

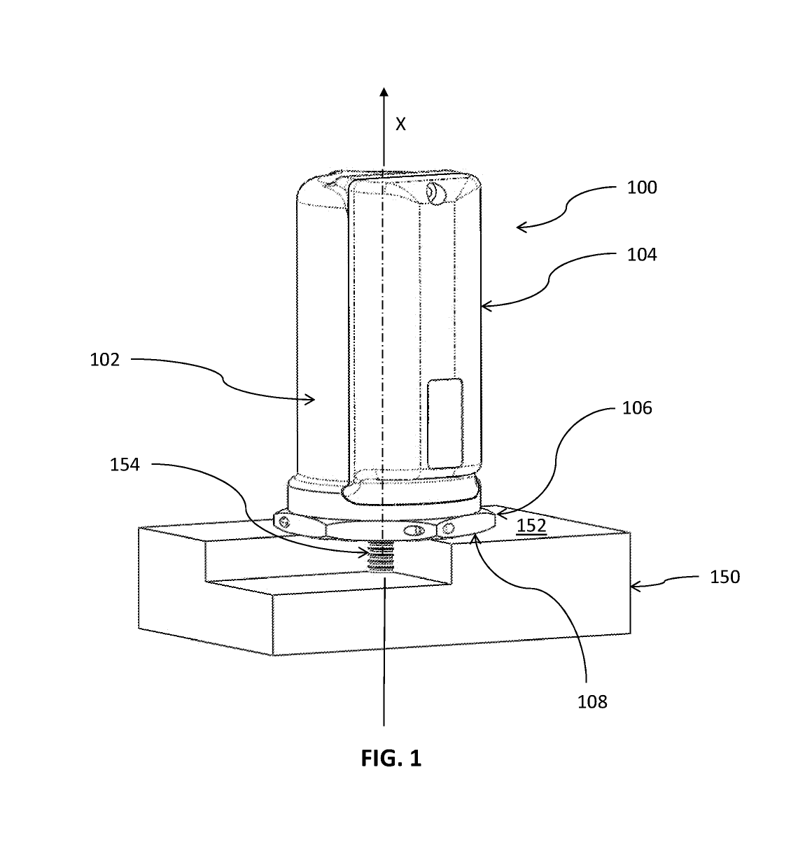

FIG. 1 illustrates a sensor 100 in accordance with various aspects of the disclosure. The sensor 100 includes a resonator housing 102 covering and protecting a resonator arrangement (discussed in detail below), an antenna housing 104 covering and protecting an antenna arrangement (discussed in detail below), and a base 106. A portion of the antenna housing 104 may be fabricated out of a material with a high electromagnetic permeability such as, for example, plastic or rubber. The resonator housing 102 may be constructed of a material having a relatively high stiffness and strength so as to protect the resonator housed therein. In some aspects, the material of the resonator housing 102 may be a metal, for example, aluminum or steel, or a composite. It may be desirable in some aspects to maximize the stiffness-to-weight ratio of the resonator housing. As shown in FIG. 1, the sensor 100 may be removably coupled with a host structure 150.

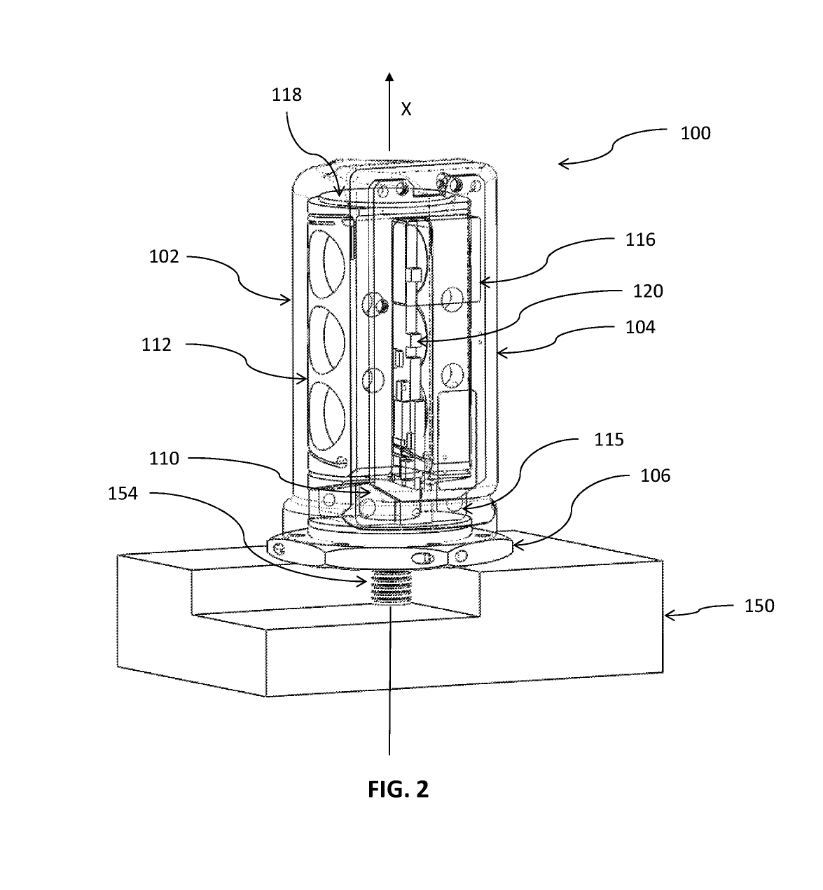

Referring to FIG. 2, the sensor 100 may further include an accelerometer 110, an energy harvester resonator 112, for example, a single degree of freedom resonator, an antenna 116, an electromechanical transducer 118, and an electronic circuit arrangement 120. According to various aspects, electromechanical transducer 118 may comprise a piezoelectric element or other electromagnetic harvesting arrangement. The electronic circuit arrangement 120 may include, for example, electronics to support sensor signal conditioning, sensor data acquisition, wireless communication, and energy harvesting.

The energy harvester inertial resonator 112, including the base 106, may comprise a single piece of unitary construction that mounts directly to the host structure 150. It should be understood that each set of mating surfaces or fastener connections between the harvester resonator 112 and host structure 150 reduces the vibration transmission to the resonator 112 and adds damping, which diminishes the performance of the energy harvester. The sensor 100 includes a minimum number of such connection/interfaces. In the embodiment shown in FIG. 1, the sensor 100 includes one interface, which is between a surface 108 of the base 106 and a mounting surface 152 of the host structure 150.

As shown in FIGS. 1 and 2, the form factor of the sensor 100 may be cylindrical in some aspects. In various aspects, the sensor 100 shape may be rectangular or any other configuration, as would be appreciated by persons skilled in the art. Packaging volume per linear dimension may be maximized within the confines of this sensor 100 using cylindrical structures where a cylindrical axis of symmetry X extends in a longitudinal direction normal to the surface 108 of the base 106. Cylindrical packaging may also be desirable for center stud mounting, which is common with accelerometers, because the sensor 100 can easily be threaded onto a mounting stud 154, for example, at a small area defined by the circular cross-section of the sensor 100. In various aspects, the base 106 may be attached to the host structure 150 with a pattern of fasteners that pass through holes in a portion of the base 106 and thread into the host structure 150 or a bracket mounted to the host structure, as would be appreciated by persons skilled in the art. Anti-rotation features such as wire-ties are used to prevent rotation of the fasteners as is commonly used in aircraft structures.

As shown in FIG. 2, the accelerometer 110 may be mounted in a recess 115 provided in the base 106 and positioned directly over the center of the base 106. For maximum accuracy, the accelerometer 110 should be located as close as possible to the base 106 and with as few mechanical interconnections as possible between the accelerometer and the host structure. With the accelerometer 110 centered over the stud 106, the influence of rocking or other modes of the entire sensor is minimized. The accelerometer transducer and associated electronics are configured such that they are electrically isolated from the base 106, resonator 112, housing 102 and other external features of the sensor 100.

In some aspects, the circuit arrangement 120 may be mounted directly to the accelerometer 110 and located on the center rectangular plane of the cylindrical sensor 100. The circuit arrangement 120 may comprise a generally planar and rectangular circuit board to maximize component packaging density and reduce cost. In some aspects, the circuit arrangement 120 may include a plurality of circuit boards, as would be understood by persons skilled in the art. Circuit board implementations may maximize packaging volume and robustness because connectors between circuit boards take up large amounts of circuit board space and present reliability concerns. The area of the circuit arrangement 120 may be maximized in the sensor 110 because the circuit planar area is usually large for supporting energy harvesting, energy storage, sensor signal conditioning, data acquisition, and wireless transmission. The present sensor 100 may achieve optimal packaging density and reliably.

The location of the circuit arrangement 120 directly adjacent to the accelerometer 110 may minimize noise entering wiring (not shown) connecting the accelerometer 110 and the signal conditioning circuitry (not shown) on the circuit board. The center location of the circuit arrangement 120 may enable the center of mass of the sensor 100 to lie over the base 106, which prevents asymmetric inertial loading at the mount and resulting rocking motion for vibration normal to the mounting surface.

The energy harvester 112 is centered over the base 106. The energy harvester 112 extracts energy from the host structure 150 based on displacement of the harvester 112 along the cylindrical axis of symmetry X. The energy is extracted through mechanical work done on a reaction force applied by the resonator 112. The center of the reaction force should correspond to the center of the base 106 in order to prevent bending moments on the base 106 which could influence the fidelity of the accelerometer measurement.

As will be described in more detail below, the resonator 112 is comprised of a discrete mass suspended by springs. When the base is accelerated, inertia of the proof mass causes deformation of the spring suspension. The suspension is instrumented with a piezoelectric element, for example, to provide mechanical-to-electrical energy transduction. The system is designed such that the suspension system of the energy harvester is tailored to the host structure's vibration characteristics. In particular, the frequency of the resonant mode of the resonator 112 matches a peak vibration level in the host structure's frequency spectrum. In one particular implementation, an energy harvester occupies ½ of a cubic inch, weighs 37 grams, and produces 6.4 mW of power at 1.0-g. It can fully power the sensor 110 down to vibration levels of 125-milli-g's. The bandwidth at 1.0-g for producing 1 mW is 80 Hz or 11% of the center frequency.

The resonator housing 102 may serve as a key structural component in addition to providing mechanical protection. In order to easily fabricate the energy harvester resonator 112, the surface the piezoelectric element 118 should be exposed and easily accessible. The cross-section of the resonator 112 should also generally have two-dimensional structures so that it can be manufactured with a wire electro-discharge machining (EDM) or extruded. These two considerations may encourage a secondary structure to provide structural rigidity to the resonator 112. The cylindrical structure of the resonator housing 102 may provide exceptionally high rigidity and reliable hydraulic sealing. The resonator housing 102 may be constructed of a material having a relatively high stiffness so as to protect the resonator 112 housed therein. In some aspects, the material of the resonator housing 102 may be a metal, for example, aluminum or steel, or a composite. It may be desirable in some aspects to maximize the stiffness-to-weight ratio of the resonator housing.

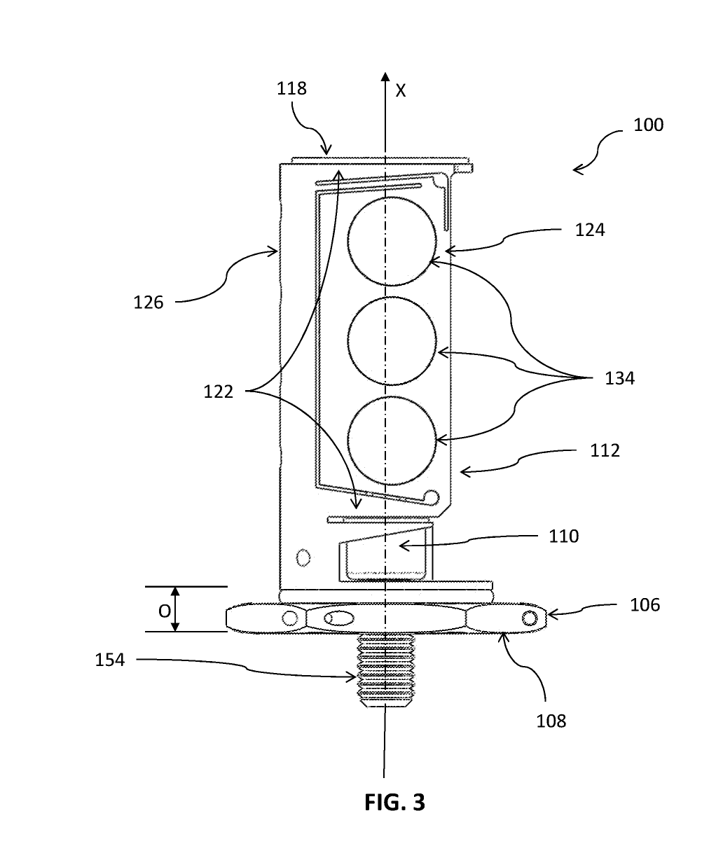

Referring now to FIG. 3, in an exemplary embodiment the resonator 112 may be a monolithic single degree of freedom resonator, similar to that described in co-pending U.S. patent application Ser. No. 13/______, entitled “Monolithic Energy Harvesting System, Apparatus, And Method” (Attorney Docket No. K014-7003US0), the disclosure of which is incorporated herein by reference. The resonator 112 may include beam-springs 122, a proof mass 124, and a backplane 126. The proof mass 124 may, in some aspects, include a slot at the center rectangular plane of the cylindrical sensor 100 so as to receive the circuit arrangement 120 therein. The mass of the proof mass 124 can be varied as a mechanism for tuning the resonance frequency of the resonator 112 after manufacturing. For example, weights can be removed from or added to the mass structure. Resonance frequency tuning may be particularly important in manufacturing where it may be undesirable to adhere to tight tolerances and specific fabrication methods which are required for achieving a precise resonance frequency.

For an energy harvester with a typical quality factor of 50 and a resonance frequency of 360 Hz, the power output will be half of the peak power, if there is a frequency mismatch of 3.6 Hz. A reasonable 1.0 Hz frequency tolerance translates to an approximate 3.6 micrometer tolerance for the thickness dimension on the 0.5 mm thick beam, assuming that all other dimensions are held perfectly to the specification. This level of precision increases the cost of the harvester and decreases its applicability in many markets. The holes 134 in the proof mass 124 are receptacles for discrete masses of different sizes and densities which change the resonance frequency of the resonator 112.

Resonance modes of the base 106 and proof mass 124 can adversely influence the performance of the resonator 112 if they lie in the frequency range for which the resonator 112 is designed to operate. The base 106 and proof mass 124 are therefore designed such that resonance modes dictated primarily by its structure will be much higher than that of the resonator's spring-proof mass resonance frequency. To achieve this, the base 106 may be designed to be stiff relative to its mass. The base 106 may be constructed with a thick cross-section, shown by the lines marked O, to maximize its first moment of area which in turn defines its flexural stiffness. The material of the base 106 may comprise, for example, a metal, a plastic, or a composite material. According to various aspects, it may be preferable that the base 106 comprise a material is one that has low intrinsic damping and high fatigue resistance such as, for example, brass, steel, titanium, or aluminum or other metals. For example, steel generally exhibits a good combination of these two characteristics.

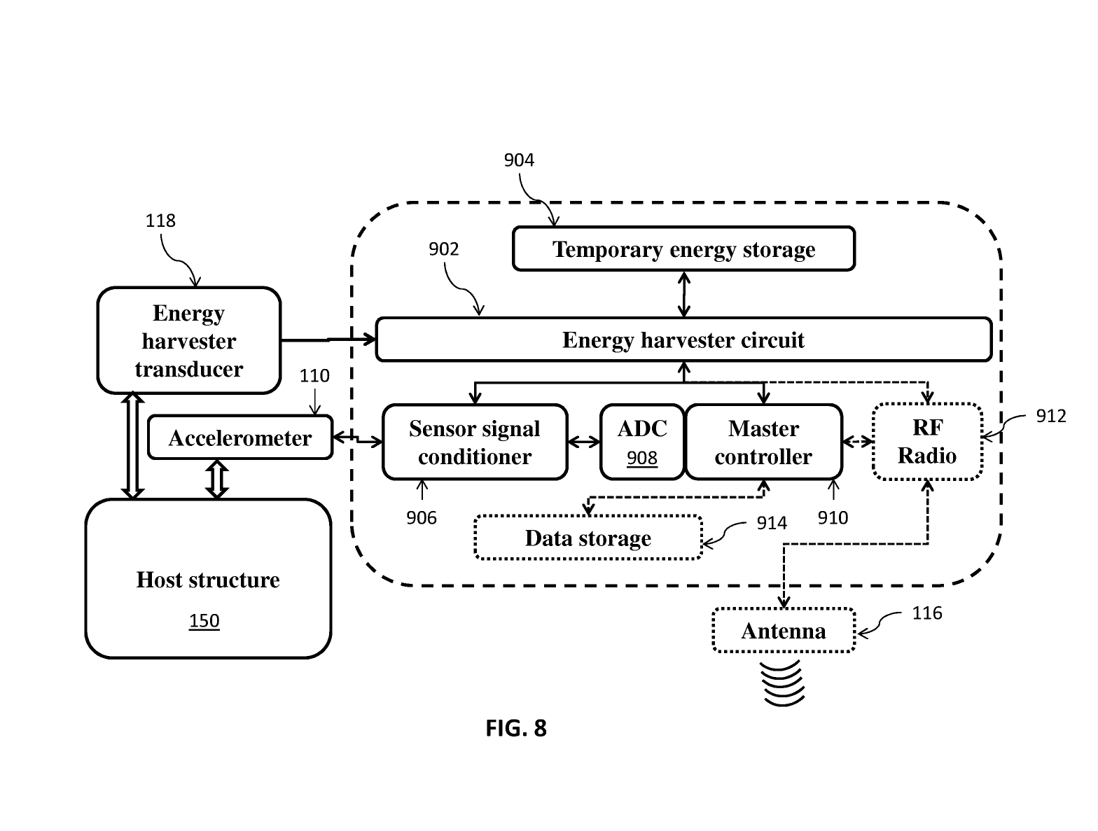

Referring now to FIG. 8, electrical circuitry 900 of the sensor may include the circuit arrangement 120 electrically coupled with the transducer 118 and the accelerometer 110, which are both mechanically coupled with the host structure 150. The electrical circuit arrangement 120 in the sensor 100 may include an energy harvester circuit 902, energy storage 904, sensor signal conditioner and power supply 906, analog-to-digital converter (ADC) 908, master controller 910, and RF radio 912. The circuit arrangement 120 may, in some aspects, also include the accelerometer 110, such as a MEMS accelerometer, data storage 914, and an antenna 916. This circuit arrangement 120 may be located on one or more circuit boards.

In an exemplary embodiment of the energy harvester circuitry 902, energy is harvested from the electromechnancal transducer 118 using an electrical circuit that includes an input voltage conditioning which may include a diode bridge, filter capacitor, over voltage protection, and DC-DC step up or down converter, an energy storage element, a voltage regulator, and an output switch. The input voltage conditioning (e.g., a diode bridge) may provide rectification of the periodic bi-polar voltage waveform from the energy harvester transducer so that a uni-polar waveform can be harvested. The uni-polar but often period rectified waveform is fed to one or more input capacitors that act as a voltage filter so that a more steady DC voltage is available for further input voltage conditioning (e.g., DC-DC converter). The input voltage conditioner may also include a DC to DC voltage step-up or step-down so that the voltage at the filter capacitor can be maintained at an optimal voltage that provides an electrical impedance match with the energy harvester transducer but is also higher or lower than the target energy storage voltage level that may be inherent to the temporary energy storage. The input voltage conditioner may be included input voltage protection to ensure that the diode rectifier and input filter capacitor are not damaged from high voltages that the energy harvester transducer may supply under certain extraneous circumstances.

The temporary energy storage 904 may also include a voltage protection feature such as a Zener diode or voltage comparator with a resistive dissipation element to protect the energy storage in the case when it is at its upper energy storage limit and the input energy exceeds the output energy of the storage element. The temporary energy storage 904 provides an energy reservoir so that an electrical load can draw power that is much higher than that supplied by the harvester for short durations. This is needed because the electrical load is generally determined by its specific application and it is often much higher than that which is available directly from the energy transducer 118. However, these loads are typically required for a brief period of time, which allows for a duty cycle operation that balances the harvester-load energy budget. The load can either be connected directly with the energy reservoir or an additional output voltage regulator can be used between the reservoir and the load. This is necessary for many applications because the energy reservoir voltage often fluctuates with the amount of energy stored while the load requires an input voltage that is fixed. In addition to the regulator, a hysteretic power supply switch is required that provides conductivity from the energy storage element 904 or voltage regulator to an electrical load which may include a signal conditioner 906, master controller 910, and RF link 912. The hysteresis is provided by a comparator circuit and is based on the energy stored in the temporary energy storage 904. The comparator circuit may include a microprocessor or other IC components.

The sensor signal conditioner and power supply 906 may include voltage regulators including linear regulators, operational amplifiers, and analog filter circuitry. The analog filters may server as a frequency band pass filter with one or more poles. The filter is designed to pass a high fidelity signal for frequencies that correspond to the ADC sampling rate. The signal conditioning stage is power by the energy harvester or the microprocessor and is in communication with the ADC 908.

The ADC 908 may be a part of the master controller or it can be a separate subsystem of the circuit arrangement 120. The master control may be a microprocessor such as a Texas Instruments MSP430 processor. In cases when the sampling rate for the accelerometer is high and the sampling duration is long, supplementary external data storage 914 to the master controller may be required. The data storage may be a type of Flash memory (non-volatile computer storage).

In one exemplary embodiment, a digital MEMS accelerometer may be used which includes ADC and signal conditioning in one IC chip. In this case the digital accelerometer would be wired directly to the master controller through a communication BUS such as SPI or I2C. It should be appreciated that an analog accelerometer may be used in some aspects.

A portion of the firmware code in the master controller, the RF radio, and the antenna comprise the wireless communication part of the sensor. The wireless communication supplies data from the master processor to a remote wireless data aggregator. It also serves as a means to maintain remote control and monitoring of the sensor node.

The RF radio is connected to an antenna which is used to optimally project and receive RF signals. The antenna may be located remotely to the circuitry or sensor external package. The antenna can be designed as a subsystem or element in the circuitry. The antenna may be a patch, chip, PCB antenna. The antenna may be located near the exterior of the sensor and with the greatest distance away from the large metal objects such as the resonator in the sensor.

Some key requirements for the wireless operation of the sensor 100 are high data throughput rate, rapid response, full duplex communication, robust data transmission, high level of data integrity, multi-node networking, and low power usage. The 2.4 GHz and 915/868 MHz bands are most appropriate for this wireless Local Area Network (LAN) and for many CBM applications. These frequency bands exhibit moderate to high data throughput to support high sensor sampling rates and good transmission performance over short distances (10-100 m). The frequency of these bands also favors small devices because antenna size roughly scales inversely with frequency for a given performance level. Straightforward power usage comparisons of IEEE 802.11 and IEEE 802.15.1 (the basis for WiFi and Bluetooth, respectively) to IEEE 802.15.4 agree with the low power objectives that are the basis for IEEE 802.15.4's inception. A star topology rather than a mesh is essential to the low power solution used in this device. In most LAN applications, transmission problems should be addressed through the inclusion of a second receiver rather than routing data through other nodes in a mesh.

Approaches for maximizing communication robustness in the presence of inter-network traffic and external wireless interference strongly impacts the communication power budget for certain protocols. Rather than using conventional spread spectrum techniques to address this problem, the approach used here takes advantage of short turn-on times, high data rate, and ultra-low power acknowledgment to enable robustness purely through rapid and repetitive retransmissions. This approach provides sufficient coexistence for most CBM wireless applications.

Building on these wireless architecture definitions requires high network throughput and rapid responsiveness. Responsiveness enables power saving strategies such as high frequency acceleration sampling at specific times corresponding to high load. Network responsiveness requires frequent full duplex communication between the sensors and receiver. The approach taken to enable this while minimizing energy consumption is to leave the line-powered receiver in a high power receiving/transmitting mode and initiate all communication from the nodes through a heartbeat. The receiver rapidly responds to node communication initiations (pings or heartbeats) by delivering acknowledgements containing payload information for the sensor. This approach minimizes the time that the node radio is on and thereby minimizes power consumption.

In order to minimize the sensor size and weight, the total system energy budget is minimized at all levels including the acceleration measurement. MEMS accelerometers can be implemented to exhibit ultra-low power operation however the current commercially available accelerometer have limited bandwidth and noise floor which precludes uses for applications requiring high fidelity measurement. If a MEMS accelerometer performance is acceptable, then the accelerometer can be mounted to the circuit board, which is centered over the base. Piezoelectric accelerometers are capable of performing wide bandwidth and high resolution measurements. However, acceleration measurement using traditional piezoelectric accelerometers can consume significant power and therefor the particular implementation of the sensor is important. Integrated charge amplifiers are generally used with piezoelectric accelerometers because they enable use of long wire connections between the accelerometer an a data acquisition system that are protected to some degree from external EMI. In wireless accelerometers, the wire length from the piezoelectric element to the microprocessor analog to digital converter can be short and therefore the integrated charge amplifier can be eliminated or redesigned for low power operation. To shorten the wire length the piezoelectric accelerometer and the circuit should be located adjacent to one another. Electrical connection pins from an accelerometer such as PCB Piezotronics' T-05 Embedded accelerometer can be soldered directly to the circuit board. Simple signal conditioning including filters and amplifiers can be implemented on the circuit board instead of using a piezoelectric accelerometer integrated charge amplifier.

### EXAMPLE

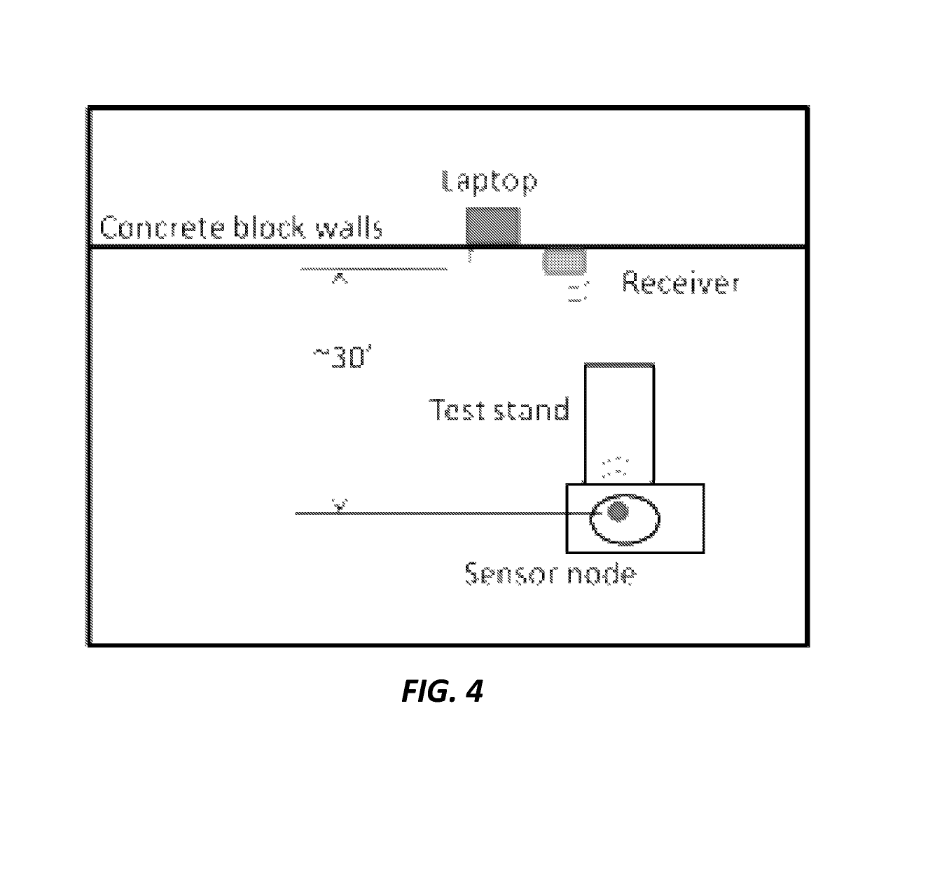

One version of the wireless energy harvester powered accelerometer was fabricated and demonstrated in a gearbox CBM application. FIG. 4 illustrates the layout for this working example. The accelerometer was oriented at a roughly 45 degree angle to horizontal. The wireless receiver was located approximately 30 feet away from the accelerometer near the concrete block wall on the far side of the room. The receiver was wired via a USB cable to a laptop located on the other side of the concrete block wall in a control room.

The wireless accelerometer was located on the far side of the gearbox relative to the receiver location. In this configuration a line-of-site path did not exist and the wireless accelerometer's peak RF propagation orientation was roughly 135° from what would be optimal for maximizing RF power at the receiver. The wireless receiver was initially installed adjacent to the laptop which was shielded from the sensor node by a concrete block wall. The concrete block wall prevented reliable communication for 0 dBm RF power levels that were used. Locating the receiver in the same room as the sensor node improved the communication reliability.

Large metal structures were located in the proximity of both the receiver and sensor. The power supply and electric motor for operating the test stand were located between the sensor and wireless receiver.

### Test Overview

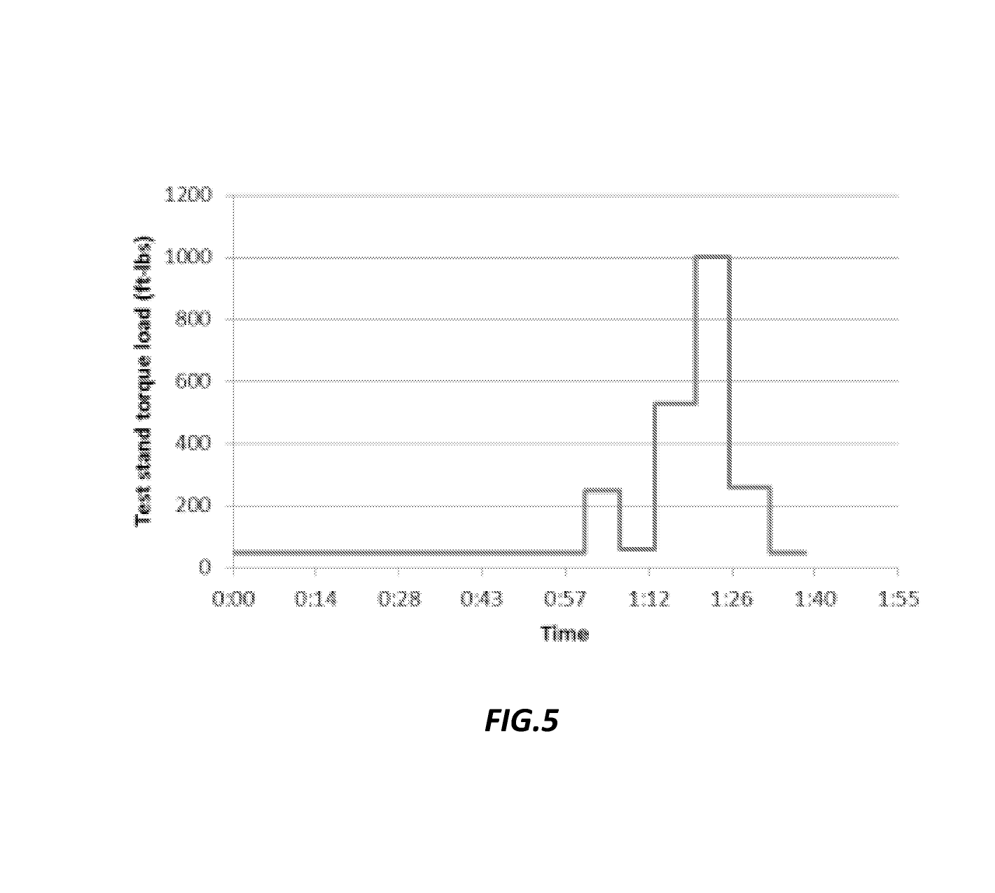

The wireless accelerometer (energy harvester powered), wireless receiver, and laptop were mounted, configured, and tested prior to spinning up the test stand. The gearbox was warmed-up under light loading prior to applying higher torque loads at the output. The test was conducted over a period of 4 different days. The sensor functionality was evaluated for a total of 14 hrs. The gearbox loading profile is shown in FIG. 5.

The sensor system was configured so that bursts of vibration data were requested every 1 minute. Data was accumulated on the laptop located in the control room. During the initial testing on Jun. 22, 2011, vibration data from a wired accelerometer located near the sensor was recorded for a reference comparison. The temperature of the gearbox was also recorded during the initial testing.

The energy harvester, accelerometer, and wireless communication links functioned properly at startup and throughout the testing without adjustment or tuning. Under the light load start-up conditions, the energy harvester charged its energy reservoir in roughly 3 minutes and began transmitting vibration data as expected. Under ideal conditions, the fully charged energy reservoir is sufficient to support 3 sequential bursts acquisitions and transmissions.

Table 1 provides an overview of the sensor system performance for 4 separate days during which the sensor was tested. The table shows the number of burst transmissions, the duration of the testing, and the average amount of data delivered per 1 hr. period. Insufficient power generation or wireless interference was responsible for delaying acquisition or wireless data transmission, which reduced the acquisition rate to an average interval of 1.5 minutes per transmission (the request were made once per minute). The average data delivery rate indicates the performance of the energy harvester rather than the over the air rate of the wireless link, which is 2 Mbps. Higher data delivery rates are possible with higher power generation levels. The data rates shown in Table 1 indicate that 1 second in duration, 50 kHz sampling rate, and with 16 bit precision vibration acquisitions could be achieved once per hour with the current energy harvester and wireless protocol.

TABLE 1
Test overview.

| Date | Jun. 22, 2011 | Jul. 12, 2011 | Jul. 13, 2011 | Jul. 14, 2011 |
|---|---|---|---|---|
| Test start time | 9:12:40 | 8:55:57 | 15:27:39 | 7:34:07 |
| Test completion time | 9:51:09 | 16:57:00 | 16:33:56 | 11:58:20 |
| Duration | 0:38:29 | 8:01:03 | 1:06:17 | 4:24:13 |
| Number of 0.7 sec., 3.2 kHz | 23 | 313 | 56 | 236 |
| sets of data transmissions | | | | |
| Average data acquisition and | 809 | 881 | 1144 | 1209 |
| delivery rate (kbits per hr.)* | | | | |

*Successful acquisition, processing, wireless transmission and retransmission (if necessary) of vibration data

The energy harvester power generation was not characterized directly but rather inferred from the system performance. An overview of the power generation performance of the sensor is shown in Table 2.

TABLE 2
Energy harvester performance.

| | Min | Typical | Max | |
|---|---|---|---|---|
| Average estimated power gene ration | 0.15 | 0.5 | 1 | mW |
| Average input vibration level | 0.2 | 0.4 | 0.7 | g |
| Frequency | | 1045 | | Hz |
| Half power bandwidth | | 30 | | Hz |

The energy harvester's resonator frequency was tuned to corresponded to a peak in the vibration spectrum at 1045 Hz. The vibration levels for the 1045 Hz peak ranged from 0.2 to 0.7 g at the sensor location depending on the gearbox torque and bending moment loading. The energy harvester is estimated to have generated on average 0.5 mW of continuous power.

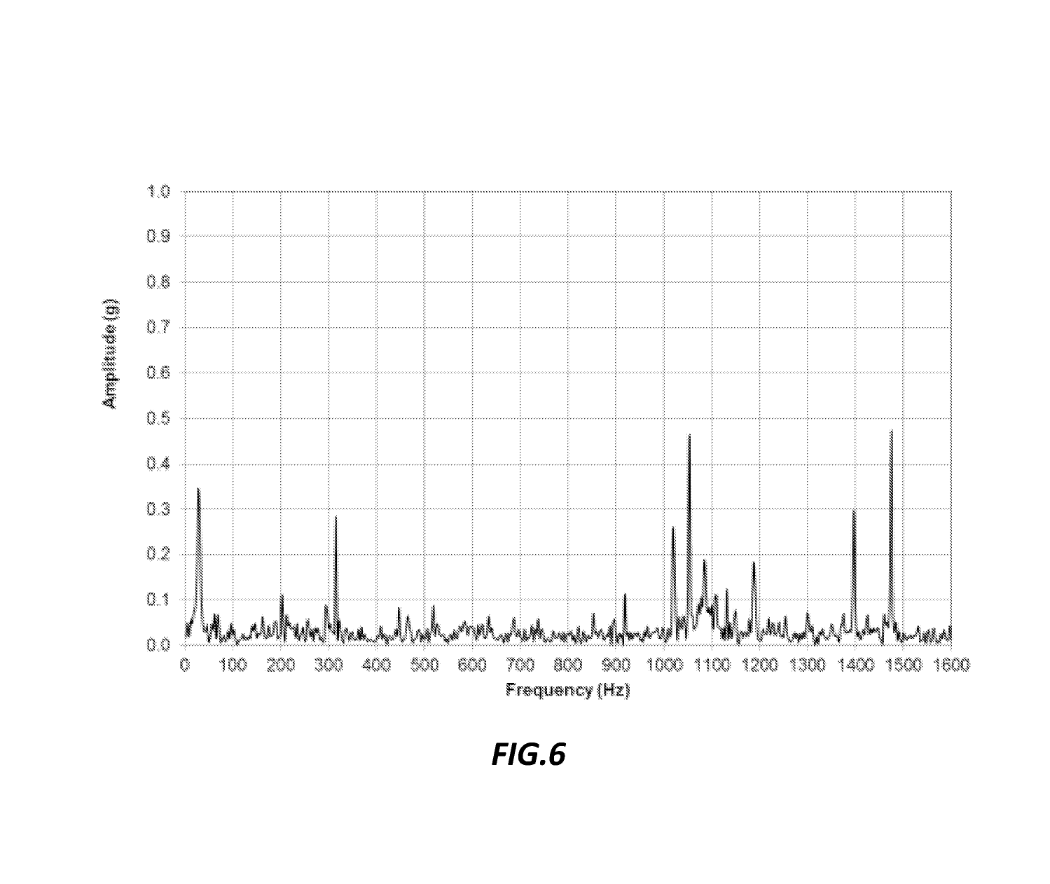

A vibration spectrum from the wireless accelerometer is shown in FIG. 6.

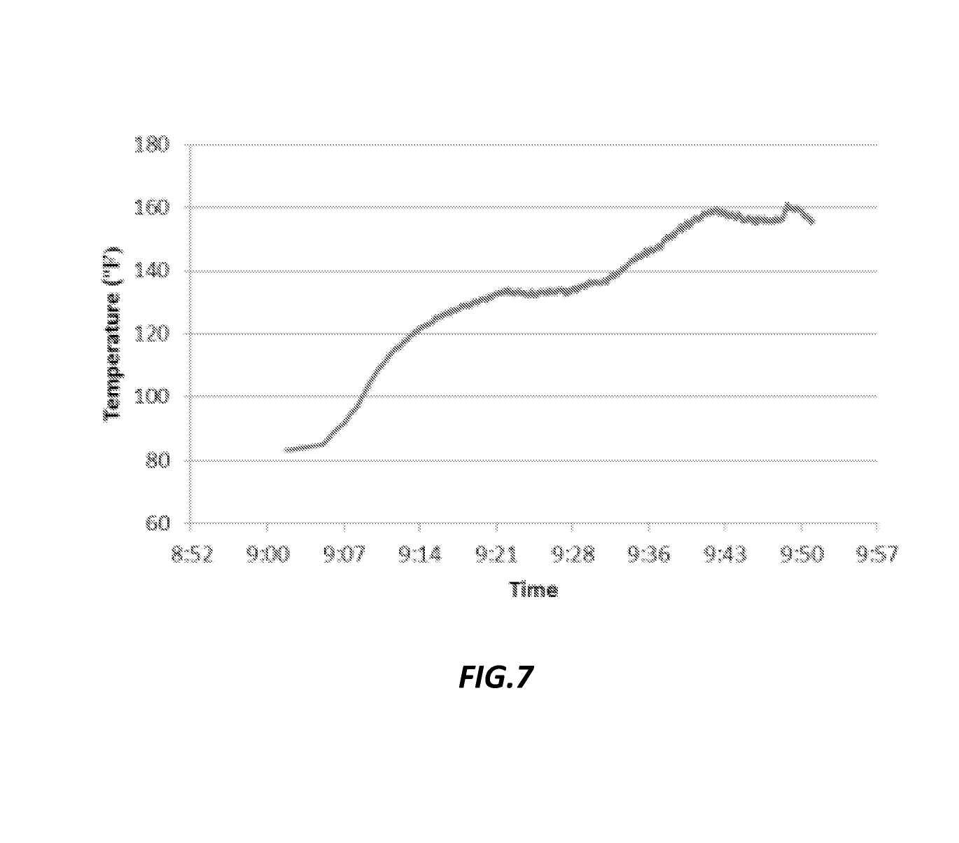

Most high power density vibration energy harvesters are generally sensitive to temperature because they are tuned devices that are intended to function optimally for a fixed frequency excitation. The gearbox temperature variation enabled testing of this dependence because the gearbox temperature ranged from 80 to 160° F. The base of the wireless accelerometer experienced temperatures similar to those recorded in FIG. 7.

The sensor data rate did not change over the duration of the test. Based on the data rate consistency, the harvester performance can be inferred to be small over this temperature range.

From the foregoing, it will be appreciated that, although specific embodiments have been described herein for purposes of illustration, various modifications or variations may be made without deviating from the spirit or scope of inventive features claimed herein. Other embodiments will be apparent to those skilled in the art from consideration of the specification and figures and practice of the arrangements disclosed herein. It is intended that the specification and disclosed examples be considered as exemplary only, with a true inventive scope and spirit being indicated by the following claims and their equivalents.

What is claimed is:

1. A sensor, comprising:
a base configured to be secured to a host structure;
a resonator centered over the base, the resonator being configured to harvest energy from vibratory motion of a host structure;
an accelerometer rigidly coupled with the base and centered over said base;
a circuit arrangement electrically coupled with the accelerometer, the circuit arrangement being configured to receive signals from the accelerometer; and
an electromechanical transducer coupled with the resonator and electrically coupled with the circuit arrangement, the electromechanical transducer being configured to convert vibratory energy of the resonator to electrical energy.

2. The sensor of claim 1, wherein the electromechanical transducer comprises a piezoelectric element.

3. The sensor of claim 1, wherein the resonator includes a base and a slot, the slot being disposed on a center rectangular plane of the resonator.

4. The sensor of claim 3, wherein the accelerometer is disposed in the base of the resonator.

5. The sensor of claim 4, wherein the circuit arrangement includes a circuit board mounted on edge and substantially centered along a centerline of the base.

6. The sensor of claim 5, wherein the circuit board is disposed on the accelerometer and in the slot on said center rectangular plane.

7. The sensor of claim 1, further comprising a wireless transceiver on the circuit arrangement.

8. The sensor of claim 7, further comprising an antenna coupled with the circuit arrangement, the antenna being configured to wirelessly transmit data from the sensor.

9. The sensor of claim 1, wherein the resonator comprises a beam spring and a proof mass.

10. The sensor of claim 1, wherein the accelerometer includes a piezoelectric element for sensing.

11. The sensor of claim 1, wherein the accelerometer comprises a micro-electrical mechanical semiconductor (MEMS) component.

12. The sensor of claim 1, wherein the resonator is configured such that a fundamental mode of resonating is a direction perpendicular to the base.

13. The sensor of claim 1, wherein the base includes holes for receiving mounting members associated with a host structure.

14. The sensor of claim 1, further comprising mounting hardware including a wire-tie feature for preventing rotation.

15. The sensor of claim 1, wherein the accelerometer is electrically decoupled from the electromechanical transducer.
